(19) United States
(12) Patent Application Publication
(10) Pub. No.: US 2021/0295445 A1
(43) Pub. Date: Sep. 23, 2021

(54) METHOD FOR AUTOMATING CUSTOMER AND VEHICLE DATA INTAKE USING WEARABLE COMPUTING DEVICES

(71) Applicant: Mitchell International, Inc., San Diego, CA (US)

(72) Inventor: Umberto Laurent Cannarsa, Carlsbad, CA (US)

(21) Appl. No.: 16/827,628

(22) Filed: Mar. 23, 2020

(51) Int. Cl. G06Q 40/08; G06Q 50/26; G07C 5/00

(52) U.S. Cl. CPC G06Q 40/08; G07C 5/008; G06Q 50/265

(57) ABSTRACT

Systems and methods are provided for automating information intake process by generating intake instructions for display on a client computing device. A user may be directed to capture data that includes vehicle and owner information using a wearable computing device. Insurance claim information, including damage information, may be obtained based on the captured vehicle information. The damage information may be used to determine intake instructions for capturing the images or videos of the damage. The user may use the system in a handsfree manner by viewing intake instructions via a display of the wearable computing device which allows the user to view the intake instructions while capturing the intake information. Additionally, the user may use voice commands or gestures to control the display of intake instructions.

### TECHNICAL FIELD

The present disclosure is generally related to automobiles. More particularly, the present disclosure is directed to automotive repair technology.

### BACKGROUND

Conventional processing of insurance claims starts with a repair estimate which involves analyzing different aspects of the damage associated with the insured item (e.g., an automotive vehicle) in order to determine an estimate of the compensation for repairing the loss.

Existing technological tools used to assist the party performing the estimate are limited to software estimation tools. However, the use of these tools is predicated upon collecting a variety of data related to the vehicle, its owner, and the damage, which traditionally comes in various formats and must be gathered from different sources, thus making conventional tools ineffective. For example, the data collection process may include paperwork processing, telephone calls, and potentially face-to-face meetings between the party conducting the estimate, the claimant, and the insurance adjuster, further delaying the settlement of the claim. Accordingly, conventional repair estimate methods are time-consuming and susceptible to human error.

### SUMMARY

In accordance with one or more embodiments, various features and functionality can be provided to enable the automation of information intake process when generating a repair estimate.

In some embodiments, a method for automating information intake may obtain vehicle identification information and owner information by processing images captured by a computing device operated by a user. In some embodiments, the computing device includes a wearable computing device worn by the user configured to facilitate hands-free intake of information associated with the owner and the damaged vehicle.

In some embodiments, the vehicle identification information and the owner information may be associated with a damaged vehicle which was damaged during an adverse incident.

In some embodiments, the method may extract Vehicle Identification Number (VIN) from a captured image of the vehicle identification information. In some embodiments, the method may obtain vehicle information associated with the damaged vehicle based on the extracted VIN. The vehicle information may include a year of manufacture, a make, a model, a sub-model, a configuration, an engine type, and a transmission type of the damaged vehicle. In some embodiments, the method may confirm vehicle identification information by receiving user input.

In some embodiments, the owner information may include a captured image of an owner driver's license card and an owner insurance card. The method may extract the owner's name from the captured image of the owner driver's license card, and extract the owner's insurance policy number from the captured image of the owner information.

In some embodiments, the method may obtain insurance claim information based on the vehicle identification information and the owner information. The insurance claim information may include damage information specifying one or more damaged parts of the damaged vehicle, and insurance intake parameters specifying one or more intake parameters. In some embodiments, obtaining insurance claim information is determined based on the extracted owner's name and the extracted owner's insurance policy number. In some embodiments, the one or more intake parameters include a number of images depicting the one or more damaged vehicle parts.

In some embodiments, the method may determine damage intake instruction information based on the damage information and insurance intake parameters associated with the insurance claim information. The damage intake instruction information may include user instructions for capturing the information associated with the one or more damaged parts of the damaged vehicle.

In some embodiments, the determined damage intake instruction information includes at least one of textual instructions and voice instructions directing the user to capture images of the one or more damaged vehicle parts associated with the damaged vehicle.

In some embodiments, the method may effectuate presentation of the damage intake instruction information for capturing the one or more damaged parts associated with the damaged vehicle using an image capture device of the computing device operated by the user. In some embodiments, effectuating the presentation of the damage intake instruction information includes displaying the textual instructions on a display of the computing device and transmitting the voice instructions via a speaker of the computing device.

### BRIEF DESCRIPTION OF THE DRAWINGS

FIG. 1 illustrates example systems and a network environment, according to an implementation of the disclosure.

FIG. 2 illustrates an example information intake server of the example environment of FIG. 1, according to an implementation of the disclosure.

FIGS. 3A-3B illustrate an example client computing device of the example environment of FIG. 1, according to an implementation of the disclosure.

FIGS. 4A-4D illustrate an example graphical user interface displaying directional instructions during an image capture of owner information, according to an implementation of the disclosure.

FIGS. 5A-5D illustrate an example graphical user interface displaying directional instructions during an image capture of damaged vehicle, according to an implementation of the disclosure.

FIG. 6 illustrates an example process for automating intake of information, according to an implementation of the disclosure.

FIG. 7 illustrates an example computing system that may be used in implementing various features of embodiments of the disclosed technology.

### DETAILED DESCRIPTION

Described herein are systems and methods for automating the intake of information used to prepare a repair estimate for a damaged vehicle. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

As stated above, conventional insurance claims adjustment process is complex and requires a claim adjuster to analyze different aspects of the damage associated with the insured item in order to determine whether compensation for the loss is appropriate. The information is obtained during an intake process that relies on manual data entry from multiple sources. For example, an intake technician may manually obtaining a claim number (e.g., a number related to damage associated with an insured vehicle, etc.) by contacting an insurance company (e.g., by phone, by email, via a company website, etc.). Further, the technician may provide basic identifying and/or validating vehicle information, including the make, model, and year of manufacture, and owner information (e.g., name, age, address, insurance information etc.) Finally, the process also includes providing information related to the general areas of damage to the vehicle and any other relevant details (e.g., condition of glass, under carriage, engine, wheels, airbags, etc. associated with the vehicle).

Accordingly, the intake process relies on manual data entry performed multiple times (e.g., first using a paper form, then a computer platform) and requires the user to utilize multiple devices (e.g., a computer and digital camera). Because manual data entry is time-consuming and is prone to errors, it often causes delays in claim processing. By allowing a user to perform the information intake process in a guided, handsfree manner results in a significant reduction in intake time and user errors. Furthermore, currently available technology lacks analytics with respect to capturing damage data. By automatically verifying the accuracy of captured information results in improved claim processing time.

In accordance with various embodiments, an intake technician can obtain intake instructions for viewing on a display of a wearable computing device. For example, a technician can view intake instruction to capture vehicle information used to identify the type of vehicle and owner information associated with the damaged vehicle without entering the information, but rather by using input devices (e.g., a camera) on the wearable computing device, resulting in handsfree data entry. Vehicle information is used to obtain claim information (e.g., from an insurance carrier) which, along with the vehicle information, is then used to determine relevant intake instructions for capturing damage information. Because the repair technician can view intake instructions via a display of a handsfree computer wearable device, the technician is able to capture the intake information at the same time. Additionally, using voice commands to move from one information capture screen to the next further enhances the handsfree operation. Finally, the technician may obtain verification that the captured data was captured in accordance with image or video standards, resulting in greater accuracy and improved processing time.

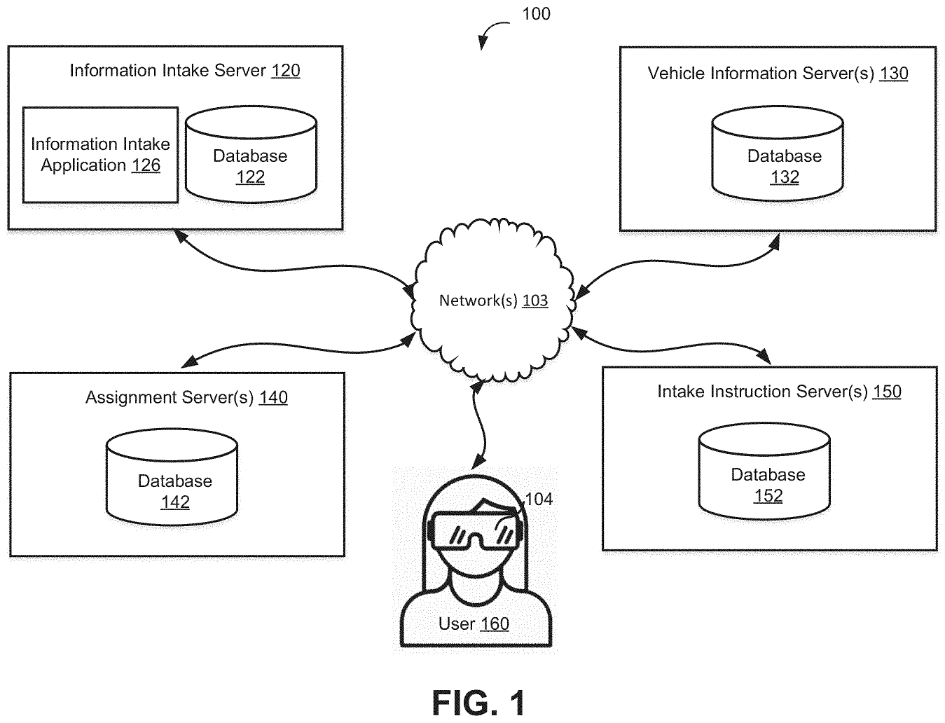

Before describing the technology in detail, it is useful to describe an example environment in which the presently disclosed technology can be implemented. FIG. 1 illustrates one such example environment 100.

FIG. 1 illustrates an example environment 100 which automates the intake of information used to prepare a repair estimate for a damaged vehicle. For example, a user conducting the intake process may collect information related to the damaged vehicle, its owner, and the damage sustained by the vehicle. The user may input the information by capturing images or by using voice commands without having to enter input via a graphical user interface (GUI) of a conventional damage estimation software, resulting in a handsfree intake process, as described herein. Furthermore, during the information intake process the user is guided by a set of intake instructions which are displayed in a client computing device 104, further facilitating the handsfree intake. In some embodiments, the set of instructions guiding the user through the information intake process may be generated based on the specific requirements of an insurance carrier (e.g., number of images to be collected), the geographic location associated with the occurrence of the incident and the issuance of the insurance policy, and/or the damage itself, as further described herein.

In some embodiments, environment 100 may include a client computing device 104, an information intake server 120, a one or more vehicle information server(s) 130, a one or more assignment information server(s) 140, a one or more intake instruction server(s) 160, and a network 103. A user 160 may be associated with client computing device 104 as described in detail below. Additionally, environment 100 may include other network devices such as one or more routers and/or switches.

In some embodiments, client computing device 104 may include a variety of electronic computing devices, for example, a computer wearable device, such as smart glasses, or any other head mounted display devices that can be used by a user (e.g., an estimator). In some embodiments, the computer wearable device may include a transparent heads-up display (HUD) or an optical head-mounted display (OHMD). In other embodiments, client computing device 104 may include other types of electronic computing devices, such as, for example, a smartphone, tablet, laptop, virtual reality device, augmented reality device, display, mobile phone, or a combination of any two or more of these data processing devices, and/or other devices.

In some embodiments, client computing device 104 may include one or more components coupled together by a bus or other communication link, although other numbers and/or types of network devices could be used. For example, client computing device 104 may include a processor, a memory, a display (e.g., OHMD), an input device (e.g., a voice/gesture activated control input device), an output device (e.g., a speaker), an image capture device configured to capture still images and videos, and a communication interface.

In some embodiments, client computing device 104 may present content (e.g., intake instructions) to a user and receive user input (e.g., voice commands). For example, client computing device 104 may include a display device, as alluded to above, incorporated in a lens or lenses, and an input device(s), such as interactive buttons and/or a voice or gesture activated control system to detect and process voice/gesture commands. The display of wearable computing device 104 may be configured to display the instructions aimed at facilitating a handsfree and voice- and/or gesture-assisted intake of information. In some embodiments, client computing device 104 may communicate with information intake server 120 via network 103 and may be connected wirelessly or through a wired connection.

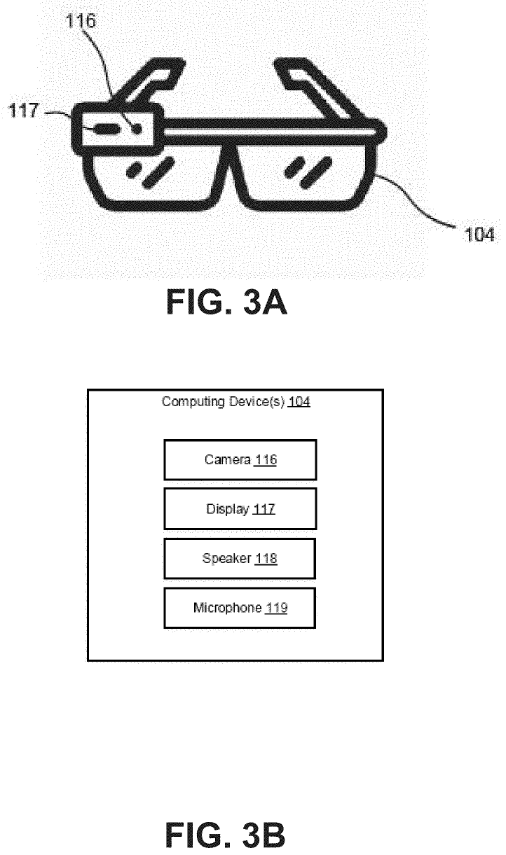

In some embodiments, client computing device 104 such as smart glasses, illustrated in FIGS. 3A-3B, may include a camera 116, a display 117 (e.g., comprising an OHMD), a speaker 118, and a microphone 119, among other standard components.

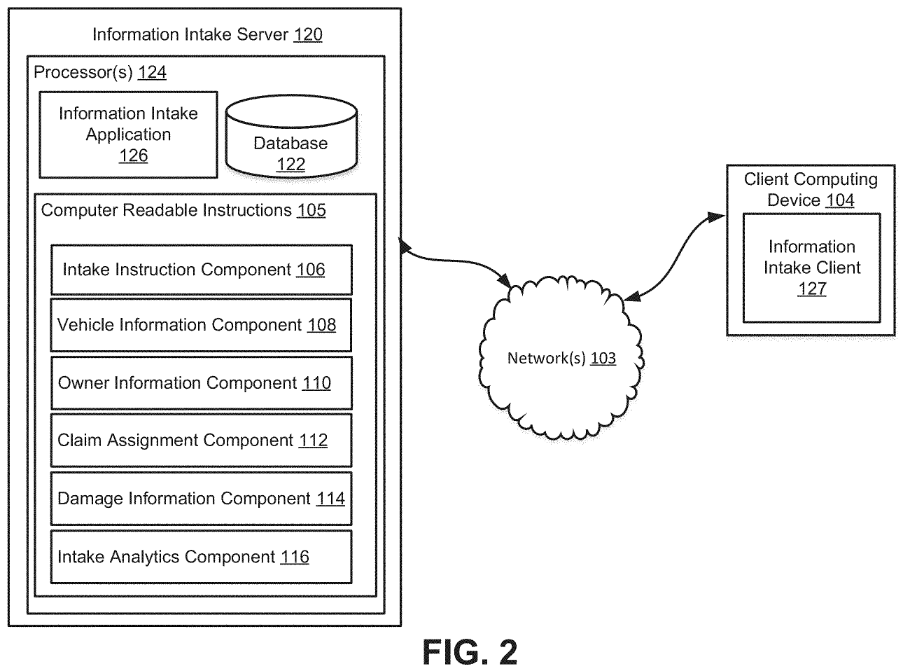

In some embodiments and as will be described in detail in FIG. 2, information intake server 120 may include a processor, a memory, and network communication capabilities. In some embodiments, information intake server 120 may be a hardware server. In some implementations, information intake server 120 may be provided in a virtualized environment, e.g., information intake server 120 may be a virtual machine that is executed on a hardware server that may include one or more other virtual machines. Additionally, in one or more embodiments of this technology, virtual machine(s) running on information intake server 120 may be managed or supervised by a hypervisor. Information intake server 120 may be communicatively coupled to a network 103.

In some embodiments, the memory of information intake server 120 can store application(s) that can include executable instructions that, when executed by information intake server 120, cause information intake server 120 to perform actions or other operations as described and illustrated below with reference to FIG. 2. For example, information intake server 120 may include information intake application 126. In some embodiments, information intake application 126 may be a distributed application implemented on one or more client computing devices 104 as client information intake viewer 127. In some embodiments, distributed information intake application 126 may be implemented using a combination of hardware and software. In some embodiments, information intake application 126 may be a server application, a server module of a client-server application, or a distributed application (e.g., with a corresponding information intake viewer 127 running on one or more client computing devices 104).

For example, user 160 may view the intake instructions displayed in a graphical user interface (GUI) of client information intake viewer 127 on a display of wearable device 104 while performing the intake process in a handsfree manner. Additionally, client computing device 104 may accept user input via microphone 119 which allows user 160 to navigate through the intake instructions by using voice commands or gesture control, again leaving the user's hands free.

As alluded to above, distributed applications (e.g., information intake application 126) and client applications (e.g., information intake viewer 127) of information intake server 120 may have access to microphone data included in client computing device 104. As alluded to above, users will access, view, and listen to intake instructions when performing data intake via client computing device 104 using voice commands or gesture control. In some embodiments, the commands entered by user 160 via microphone 119 of client computing device 104 (illustrated in FIG. 3B) may be recognized by information intake application 126. For example, a command entered by user 160 may include user 160 speaking “View Damage Intake Instructions” into microphone 119. In some embodiments, information intake application 126 may have access to audio data collected by microphone 119 of client computing device 104. That is, information intake application 126 may receive voice commands as input and trigger display events as output based on the voice commands of user 160, as described in further detail below. In yet other embodiments, information intake application 126 may receive voice commands as input and trigger voice response events as output based on the voice commands of user 160, as further described in detail below.

The application(s) can be implemented as modules, engines, or components of other application(s). Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the repair management computing device itself, may be located in virtual server(s) running in a cloud-based computing environment rather than being tied to one or more specific physical network computing devices. Also, the application(s) may be running in one or more virtual machines (VMs) executing on the repair management computing device.

In some embodiments, information intake server 120 can be a standalone device or integrated with one or more other devices or apparatuses, such as one or more of the storage devices, for example. For example, information intake server 120 may include or be hosted by one of the storage devices, and other arrangements are also possible.

In some embodiments, information intake server 120 may transmit and receive information to and from one or more of client computing devices 104, one or more vehicle information servers 130, one or more assignment servers 140, one or more intake instruction servers 150, and/or other servers via network 103. For example, a communication interface of the information intake server 120 may be configured to operatively couple and communicate between client computing device 104 (e.g., a computer wearable device), vehicle information server 130, assignment server 140, intake instruction server 150, which are all coupled together by the communication network(s) 103.

In some embodiments, vehicle information server 130 may be configured to store and manage vehicle information associated with a damaged vehicle. For example, vehicle information may include vehicle identification information, such as VIN number, make, model, and optional modifications (e.g., sub-model and trim level), date and place of manufacture, and similar information related to a damaged vehicle. The vehicle information server 130 may include any type of computing device that can be used to interface with the information intake server 120. For example, vehicle information server 130 may include a processor, a memory, and a communication interface, which are coupled together by a bus or other communication link, although other numbers and/or types of network devices could be used. In some embodiments, vehicle information server 130 may also include a database 132. For example, database 132 may include a plurality databases configured to store content data associated with vehicle information, as indicated above. The vehicle information server 130 may run interface applications, such as standard web browsers or standalone client applications, which may provide an interface to communicate with the repair management computing device via the communication network(s). In some embodiments, vehicle information server 130 may further include a display device, such as a display screen or touchscreen, and/or an input device, such as a keyboard, for example.

In some embodiments, assignment server 140 may be configured to store and manage data related to an insurance carrier or other similar entity with respect to a damage incident (e.g., a collision accident). For example, the data related to an insurance carrier may include a claim number which was assigned by the insurance carrier upon submitting an insurance claim reporting a damage incident, information related to the insurance carrier, the owner of the damaged vehicle, the vehicle, the damage reported during claim submission for adjustment, policy information, and other similar data. In some embodiments, assignment server 140 may include any type of computing device that can be used to interface with the information intake server 120 to efficiently optimize handsfree guided intake of information related to a damaged vehicle for the purpose of generating a repair estimate. For example, assignment server 140 may include a processor, a memory, and a communication interface, which are coupled together by a bus or other communication link, although other numbers and/or types of network devices could be used. In some embodiments, assignment server 140 may also include a database 142. For example, database 142 may include a plurality databases configured to store content data associated with insurance carrier policy and claim, as indicated above. In some embodiments, assignment server 140 may run interface applications, such as standard web browsers or standalone client applications, which may provide an interface to communicate with the information intake server 120 via the communication network(s) 103. In some embodiments, assignment server 140 may further include a display device, such as a display screen or touchscreen, and/or an input device, such as a keyboard, for example.

In some embodiments, intake instruction server 150 may be configured to store and manage information associated with intake instructions. Intake instruction server 150 may include processor(s), a memory, and a communication interface, which are coupled together by a bus or other communication link, although other numbers and/or types of network devices could be used. In some embodiments, intake instruction server 150 may also include a database 152. For example, database 152 may include a plurality databases configured to store content data associated with intake instructions (e.g., workflow intake instructions, including textual information, images, videos, with and without an audio guide, and/or animations, including 3D animations) demonstrating how to perform intake of various information fora variety of different types and models of vehicles with different types of damage, which are insured by different insurance carriers in different geographical locations that may have different image requirements.

In some embodiments, vehicle information server 130, assignment servers 140, and intake instruction servers 150 may be a single device. Alternatively, in some embodiments, vehicle information server 130, assignment servers 140, and intake instruction servers 150 may include a plurality of devices. For example, the plurality devices associated with vehicle information server 130, assignment servers 140, and intake instruction servers 150 may be distributed across one or more distinct network computing devices that together comprise one or more vehicle information server 130, assignment servers 140, and intake instruction servers 150.

In some embodiments, vehicle information server 130, assignment server 140, and intake instruction server 150, may not be limited to a particular configuration. Thus, in some embodiments, vehicle information server 130, assignment server 140, and intake instruction server 150 may contain a plurality of network devices that operate using a master/slave approach, whereby one of the network devices operate to manage and/or otherwise coordinate operations of the other network devices. Additionally, in some embodiments, vehicle information server 130, assignment server 140, and intake instruction server 150 may comprise different types of data at different locations.

In some embodiments, vehicle information server 130, assignment server 140, and intake instruction server 150 may operate as a plurality of network devices within a cluster architecture, a peer-to-peer architecture, virtual machines, or within a cloud architecture, for example. Thus, the technology disclosed herein is not to be construed as being limited to a single environment and other configurations and architectures are also envisaged.

Although the exemplary network environment 100 with computing device 104, information intake server 120, vehicle information server 130, assignment server 140, intake instruction server 150, and network(s) 103 are described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment, such as client computing device 104, information intake server 120, vehicle information server 130, assignment server 140, and/or intake instruction server 150 may be configured to operate as virtual instances on the same physical machine. In other words, one or more of computing device 104, information intake server 120, assignment server 140, and/or intake instruction server 150, may operate on the same physical device rather than as separate devices communicating through communication network(s). Additionally, there may be more or fewer devices than computing device 104, information intake server 120, vehicle information server 130, assignment server 140, and/or intake instruction server 150.

In addition, two or more computing systems or devices can be substituted for any one of the systems or devices, in any example set forth herein. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including, by way of example, wireless networks, cellular networks, PDNs, the Internet, intranets, and combinations thereof.

In some embodiments, the various below-described components of FIG. 2, including methods, and non-transitory computer readable media may be used to effectively and efficiently optimize handsfree guided repair management of a damaged vehicle.

FIG. 2 illustrates an example information intake server 120 configured in accordance with one embodiment. In some embodiments, as alluded to above, information intake server 120 may include a distributed information intake application 126 configured to guide the user during the intake of information process, analyze the intake input (e.g., information related to the damaged vehicle and the owner) in order to determine vehicle information (e.g., VIN number and license plate number), determine carrier claim number associated with the vehicle based on the vehicle and/or owner information, if any, and generate intake instructions for capturing information related to the damage sustained by the vehicle in order to ensure compliance with specific carrier instructions. The intake instructions may be displayed on a display associated with client computing device 104, as further described in detail below. In some embodiments, user 160 may view the intake instructions, the captured intake information, and any information determined by information intake server 120 via a GUI associated with information intake viewer 127 running on client computing device 104.

In some embodiments, information intake server 120 may also include one or more database(s) 122. For example, database 122 may include a database configured to store data associated with intake instructions generated by information intake server 120 which are accessed and used by user 160 when performing the intake. Additionally, database 122 may store intake information captured by user 160, as further described in detail below. Additionally, one or more databases of information intake server 120 may include data related to user's 160 current and past interactions or operations with information intake server 120, such as voice commands, gesture commands, and other input collected during the intake process.

In some embodiments, distributed information intake application 126 may be operable by one or more processor(s) 124 configured to execute one or more computer readable instructions 105 comprising one or more computer program components. In some embodiments, the computer program components may include one or more of an intake instruction component 106, a vehicle information component 108, an owner information component 112, a claim assignment component 112, a damage information component 114, an intake analytics component 116, and/or other such components.

In some embodiments, intake instruction component 106 may be configured to generate handsfree directional intake instructions for guiding user 160 during the intake process. The intake instructions may include instructions for capturing vehicle information, owner information, and information related to the damage sustained by the vehicle. In some embodiments, the directional instructions may be shown on a display of computer wearable device 104.

In some embodiments, intake instruction component 106 may be configured to provide programmed instructions that instruct user 160 (e.g., a person performing a repair estimate) that is wearing client computing device 104 to capture vehicle owner information, such as owner's driver's license, insurance information, and other similar information. Further, intake instruction component 106 may be configured to provide programmed instructions that instruct user 160 to capture vehicle identification information, such as a vehicle identification number (VIN). Finally, intake instruction component 106 may be configured to provide programmed instructions that instruct user 160 to capture additional vehicle information (e.g., odometer reading, etc.) as well as damage information related to the damaged vehicle (e.g., images of damaged panels or parts), as will be described further below.

For example, user 160 may capture an image associated with a VIN and/or license plate of the damaged vehicle, owner's driver's license, owner's automobile insurance policy, and so on. In other embodiments, user 160 may provide vehicle identification information, such as audio data captured by a microphone (e.g., microphone 119, illustrated in FIG. 3B) of client computing device 104. Similarly, user 160 may capture an image associated with owner's driver's license or automobile insurance policy card.

In some embodiments, the intake instructions for capturing vehicle, owner, and damage information may include text and/or directional arrows showing where to locate particular information. With respect to vehicle information, the intake instructions may include text and/or directional arrows showing where the VIN is located or information indicating to user 160 when the VIN or license plate is in a view plane that is acceptable for image capture.

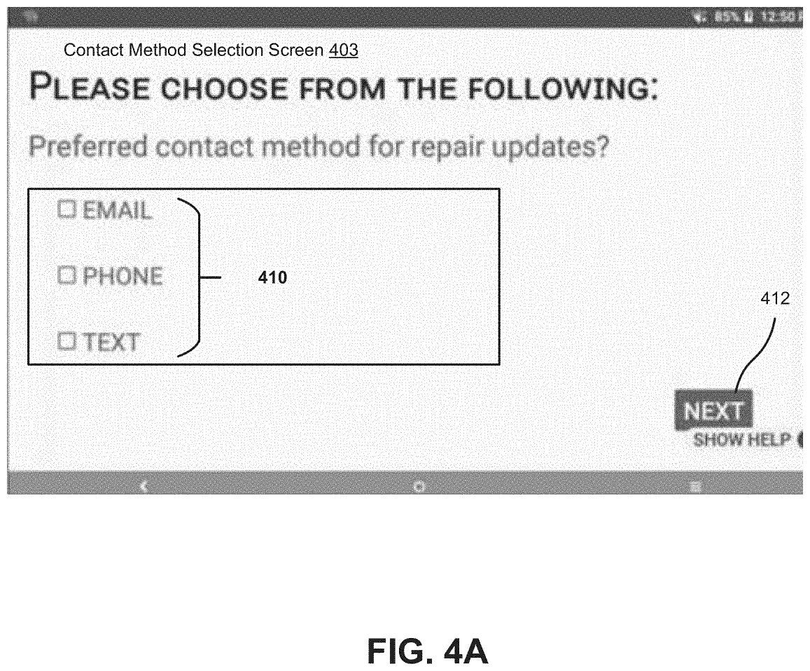

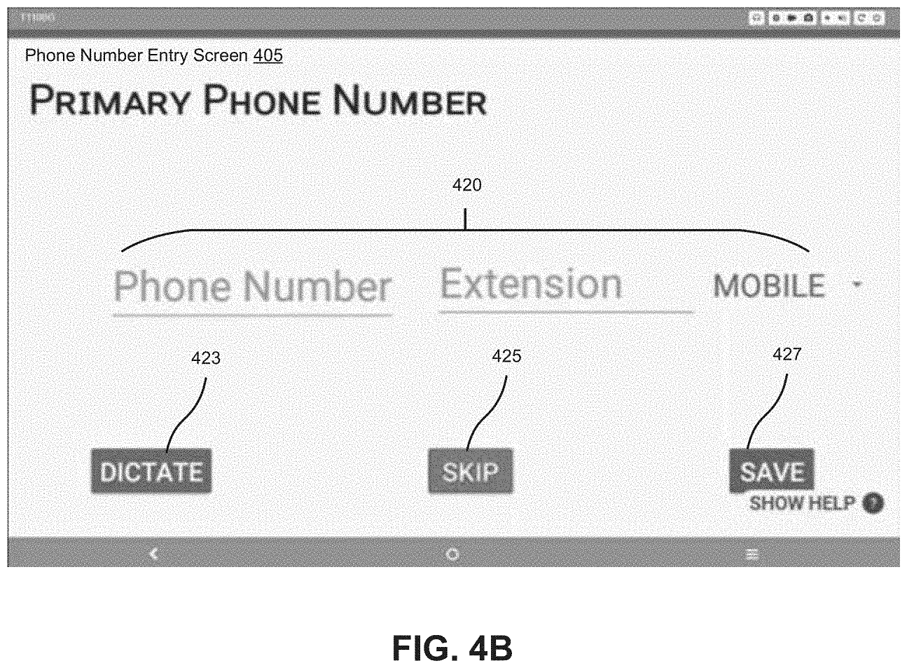

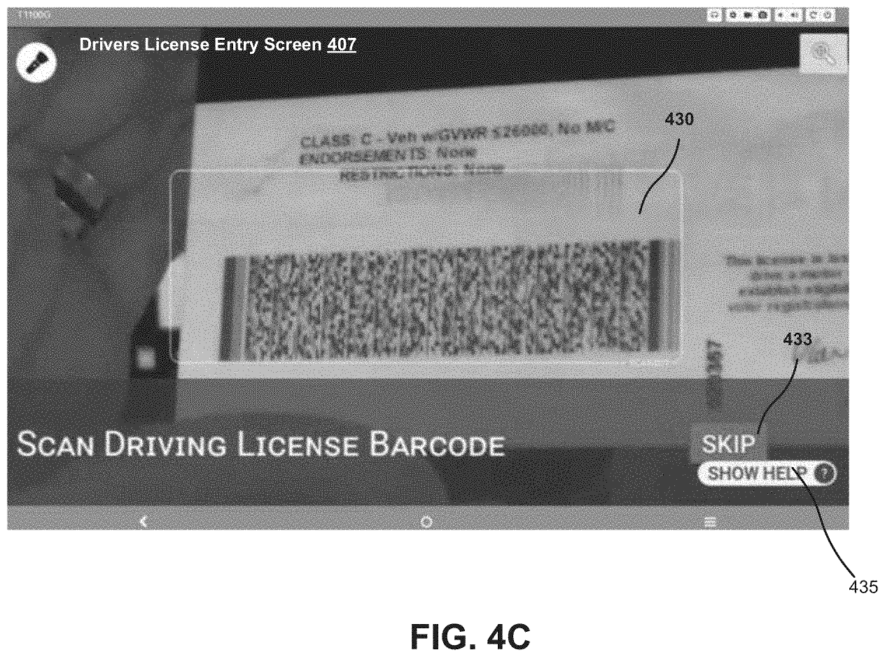

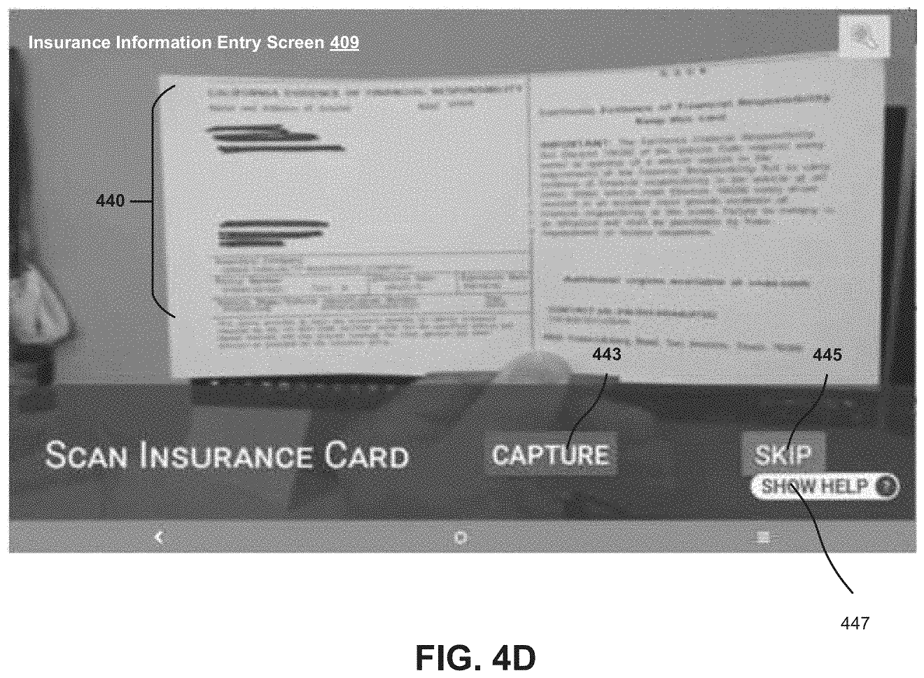

In some embodiments, user 160 may select what information is being captured (e.g., owner or vehicle). Upon selecting the capture of owner information, user 160 may be presented with instructions for capturing the information associated with the owner of damaged vehicle, as illustrated in FIGS. 4A-4D. For example, in FIG. 4A, user 160 may be presented with a contact method selection screen 403 within a display (e.g., OHMD) of computer wearable device 104 when capturing information pertaining to the owner of the damaged vehicle. User 160 may input the owner's preferred method of contact 410 (e.g., email, phone, or text) for receiving repair updates. User 160 may input the preferred method by voice entry, for example.

Upon selecting the preferred method of contact as phone or text, user 160 may be presented with a phone number entry screen 405 within the display of computer wearable device 104, as illustrated in FIG. 4B. Phone number entry screen 405 may be used by user 160 to input owner's phone number 420. User may input the phone number by voice entry, for example by selecting “Dictate” command 425. Upon completing the entry of phone number 420, user 160 may choose to save the information by speaking “Save” command 427. Alternatively, user may choose to skip the entry of the phone number by speaking “Skip” command 425.

In some embodiments, user 160 may input owner's driver's license information. For example, as illustrated in FIG. 4C, user 160 may be presented with a driver's license entry screen 407 within the display of computer wearable device 104. Driver's license entry screen 407 may include instructions that guide user 160 to center the image capture device of client computing device 104 on a driver's license card 430 during the image capture process. During the capture of driver's license 430, user 160 may choose to get additional instructions by speaking “Show Help” command 435. Alternatively, user 160 may choose to skip the entry of driver's license information by speaking “Skip” command 433.

In some embodiments, user 160 may input owner's insurance information. For example, as illustrated in FIG. 4D, user 160 may be presented with an insurance information entry screen 409 within the display of computer wearable device 104. Insurance information entry screen 409 may include instructions that guide user 160 to center the image capture device of client computing device 104 on the insurance card 440 during the image capture process. As user 160 has centered the image capture device of client computing device 104 on the insurance card 440, user 160 may speak “Capture” command 443 to complete the image capture. During the capture of insurance card 440, user 160 may choose to get additional instructions by speaking “Show Help” command 447. Alternatively, user 160 may choose to skip the entry of insurance card information by speaking “Skip” command 445.

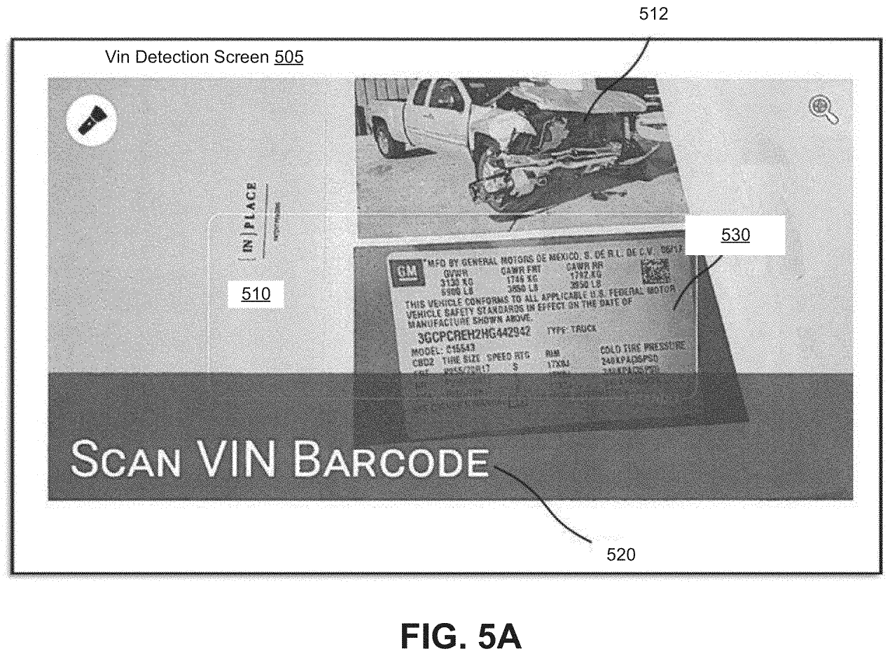

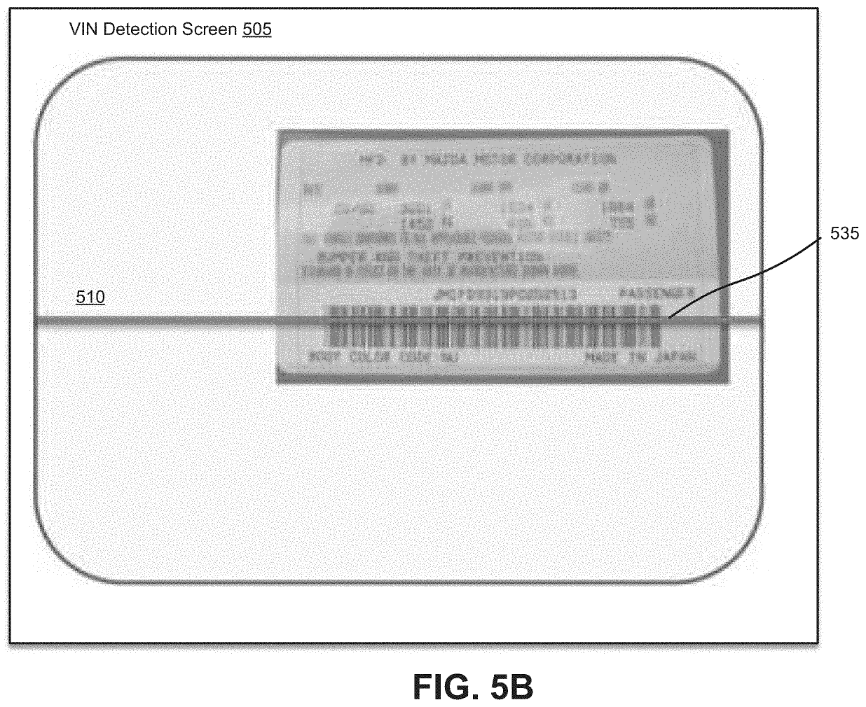

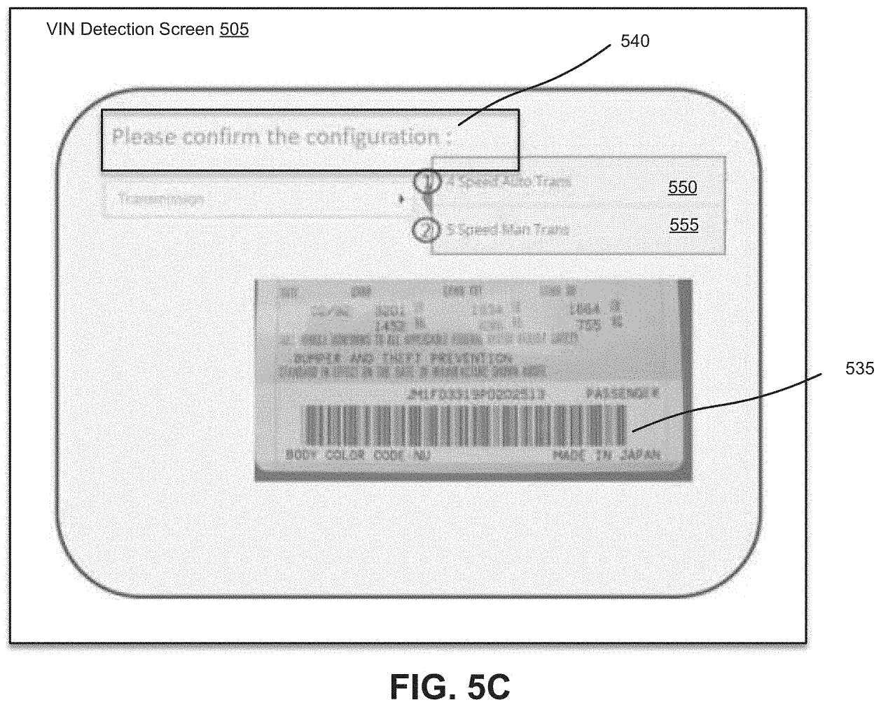

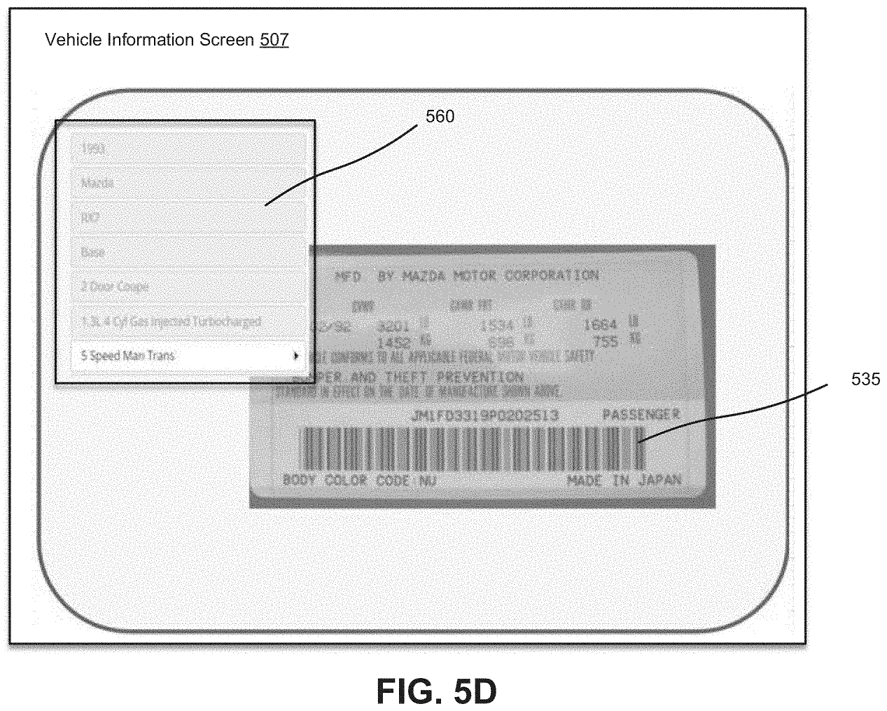

As alluded to above, user 160 may select the capture of the damaged vehicle information. Accordingly, user 160 may be presented with instructions for capturing the information associated with the damaged vehicle, as illustrated in FIGS. 5A-5D. For example, as illustrated in FIG. 5A, user 160 may be presented with VIN detection screen 505 within the display of computer wearable device 104 when capturing vehicle information of damaged vehicle 512. VIN detection screen 505 may include instructions 520 that guide user 160 to center the image capture device of client computing device 104 on a VIN card 430 during the image capture process. For example, as illustrated in FIG. 5B, a field of view window 510 may focus on a VIN barcode 535. In some embodiments, instructions 520 may appear under field of view window 410 within VIN detection screen 505.

In some embodiments, directional instructions may include one or more voice commands transmitted to speaker 118 of client computing device 104 (illustrated in FIG. 3B) informing user 160 what and/or when to capture the image associated of the vehicle, owner, or damage information. Different types of directional instructions may include voice commands, visual prompts, such as written text and arrows, or some combination of the above.

For example, as illustrated in FIG. 5C, upon scanning VIN barcode 535, directional instructions 540 may be presented to user 160. Directional instructions 540 may be requesting confirmation of vehicle configuration. For example, user 160 may input that damaged vehicle's transmission is either automatic or manual. User 160 may confirm transmission 555 by either speaking the corresponding transmission types 550, 555 or by speaking the menu number associated with each transmission type (e.g., 4 or 5).

In some embodiments, intake instruction component 106 may generate directional instructions based on the positional information of user 160. For example, user 160 may obtain information associated with user's 160 location with respect to the vehicle. Next, intake instruction component 106 may determine that user 160 is not proximately positioned to the location or area corresponding to a part of the vehicle that displays the VIN number (e.g., windshield), and generate an audio command instructing the user 160 to move to the correct location. That is, upon determining that user 160 is not in the location or area corresponding to the part of the vehicle that displays the VIN number, the instructions may assist the user in located the correct area. In some embodiments, when determining user's 160 location with respect to the vehicle, intake instruction component 106 may use one or more of computer vision, device tracking, augmented reality, or similar technologies to identify user's location.

In some embodiments, intake instruction component 106 may be configured to generate a handsfree confirmation informing user 160 that the image capture process of vehicle information, owner information, and/or damage information was accomplished successfully. In some embodiments, the confirmation may include a message shown on the display of computer wearable device 104. In yet other embodiments, confirmation may include one or more voice commands transmitted to speaker 118 of client computing device 104 (illustrated in FIG. 3B) informing user 160 that the image capture process was accomplished successfully.

In some embodiments, vehicle information component 108 may be configured to collect vehicle information that user 160 captured when being guided by intake instruction component 106. For example, vehicle information component 108 may collect captured image data of the VIN, the license plate number, and other similar information related to the damaged vehicle.

In some embodiments, vehicle identification component 108 may process the captured image data to extract the VIN or license plate number from the captured image data. For example, vehicle identification component 108 may utilize stored optical character recognition programmed instructions to extract the VIN or license plate from the captured image data.

In some embodiments, vehicle identification component 108 may present all information related to the damaged vehicle upon user 160 capturing relevant data, as described herein. For example, as illustrated in FIG. 5D, upon scanning VIN barcode 535 (illustrated in FIG. 5B) and inputting additional information (illustrated in FIG. 5C), vehicle information screen 507 may present vehicle information 460 to user 160. Vehicle information 560 may include year of manufacture (e.g., 1993), make (e.g., Mazda), model (e.g., RX7), configuration (e.g., base), style (e.g., 2 door coupe), engine type (e.g., a 1.3 L. 4 cylinder, gas injected turbocharged engine), and transmission type (e.g., 5 speed manual transmission).

In some embodiments, vehicle information component 108 may obtain vehicle information related to the damaged vehicle based on the extracted captured image data. For example, vehicle information component 108 may query database 132 of vehicle information server 130 (illustrated in FIG. 1) to obtain the make, model, and year of manufacturing of the vehicle by using the extracted VIN.

In some embodiments, owner information component 110 may be configured to collect vehicle owner information that user 160 captured when being guided by intake instruction component 106. For example, owner information component 110 may collect captured image data of the owner's driver's license, the automobile insurance policy, and other similar information related to the owner of the damaged vehicle.

In some embodiments, owner information component 110 may process the captured image data to extract the owner's biographical information (e.g., name, address, phone number, and so on) and driver information (e.g., driver's license number, state, driver's license expiration date, and so on). Additionally, owner information component 110 may extract insurance carrier name, insurance policy name, number, and other carrier related information from the captured image data. Similar to the vehicle information component 108, owner information component 110 may utilize stored optical character recognition programmed instructions to extract owner's name or driver's license number from the captured image data.

In some embodiments, claim assignment component 112 may obtain automobile insurance policy claim information associated with the vehicle by using the vehicle information obtained by vehicle information component 108 and/or owner information obtained by owner information 110. For example, claim assignment component 112 may query database 142 of assignment server 140 (illustrated in FIG. 1) to obtain an insurance claim information (e.g., claim number) associated with the damaged vehicle having a particular VIN, belonging to a particular owner, whose vehicle is covered by a particular insurance carrier, and/or having a particular insurance policy name and number. The insurance policy claim information associated with the vehicle may include information related to the damage the vehicle sustained during the incident, as reported during claim submission. The damage information included in the insurance policy claim may be used to determine intake instructions for capturing the images or videos of the damage, as described further below. For example, the damage information may include wide shots of the damaged vehicle, pictures of an identification number associated with the damaged vehicle (e.g., a vehicle identification number (VIN), etc.), current odometer reading, and/or multiple angles/close-up shots of the damage associated with the insured vehicle. In some embodiments, intake instructions may be generated to require that user 160 captures image data related to at least two different angles of the damage for each panel (e.g., hood, fender, door, bumper, etc.) based on the claim description of the damage.

Notably, in some embodiments, claim assignment component 112 may not obtain a claim number and may proceed in providing user instructions on the types of image data that should be captured without receiving a claim number. The user may receive generic or non-specific intake instructions on capturing information related to the damaged vehicle, e.g., various photos/video of the damaged areas, including photos/video of the entire vehicle, photos of VIN door tag, current odometer reading, and so on.

Further, by obtaining the insurance claim information associated with the damaged vehicle, the information intake server 120 may prepare a corresponding repair estimate report populated by information captured during the intake process, as described herein.

In some embodiments, intake instruction component 106 may be configured to generate handsfree directional intake instructions for guiding user 160 during the intake of the information related to the damage sustained by the vehicle. For example, the damage information (e.g., photos and videos) that user 160 must capture in order to prepare a repair estimate for a damaged vehicle may be dependent on vehicle information previously determined by vehicle information component 108, owner information component 110 and/or claim assignment component 112.

As alluded to earlier, the intake instructions may be dependent on the geographic location (e.g., country or state) where the incident occurred, the insurance carrier, including its geographic location, or the type of owner's insurance policy. For example, different insurance carriers may have different requirements for the information being submitted when preparing a repair estimate, e.g., the requirements may specify the number, type of view (i.e., side, front, etc.), and/or content of images (i.e., damaged areas, undamaged areas, previously damaged areas, interior of the vehicle and other similar areas,). Thus, one insurance carrier may require only one image (e.g., only front view) depicting the damage, while other carriers may require multiple images of different views (i.e., front and side views) that depict the damage.

In some embodiments, intake instruction component 106 may query database 152 of intake instruction server 150 (illustrated in FIG. 1) to obtain intake instructions by using, for example, the extracted VIN information, the geographic location information associated with the occurrence of the incident and the issuance of the insurance policy, and/or other such information obtained by vehicle information component 108, owner information component 110 and/or claim assignment component 112.

Additionally, the intake instructions may be dependent on the type of damage, its severity, and/or other factors related to the damage. For example, capturing vehicle damage associated with a frontal grill may include instructions for capturing images depicting side fenders in addition to the frontal grill. Accordingly, intake instruction component 106 may be configured to generate intake instructions for gathering damage data based on the claim information obtained by claim assignment component 112 (e.g., insurance policy claim information may include information related to the damage the vehicle sustained during the incident, as reported during claim submission).

By using the damage information obtained by claim assignment component 112, insures that user 160 automatically receives all relevant instructions for capturing intake information in a handsfree manner (i.e., without consulting additional documents) resulting in an efficient intake process.

As set forth above, a damaged vehicle may have more than one area that has been damaged during an incident. For example, in a collision accident, a vehicle may have damage to a front bumper, a windshield, and a front passenger door. Accordingly, intake instruction component 106 may obtain intake instructions based on a particular vehicle panel indicated by visual input, e.g., image data captured by user 160 wearing client computing device 104. For example, a front fender of a damaged vehicle may be included in the visual input provided by client computing device 104. Upon processing the captured image data and identifying one or more vehicle panels that have been damaged, intake instruction component 106 may automatically obtain intake instructions for capturing damage to those vehicle panels.

In some embodiments, damage information component 114 may be configured to collect damage information that user 160 captured when being guided by intake instruction component 106. For example, damage information component 114 may collect captured image data associated with various panels and parts of the damaged vehicle.

In some embodiments, intake instruction component 106 may be configured to effectuate presentation of intake instructions via a GUI associated with information intake viewer 127 running on client computing device 104 operated by user 160. For example, intake instruction component 106 may effectuate presentation of one or more screens that user 160 may navigate using voice commands or gesture control, as set forth above. In some embodiments, each screen may be identified via a corresponding label. For example, a screen associated with intake of vehicle information may be identified as “Vehicle Information” or a similar descriptive label. Similarly, the screen associated with intake of owner information may be identified as “Owner Information”, and so on. In some embodiments, vehicle information determined by vehicle component 108 (e.g., VIN) may be displayed in subsequent information intake screens.

In some embodiments, the first screen may include one or more options for additional information available for selection by user 160. The one or more options may also be identified via a corresponding label. User 160 may select a particular option by using a voice command, a gesture control, or other command associated with the label. For example, user 160 may select between “customer check-in” or “vehicle check-in” workflows.

In some embodiments, intake instruction component 106 may be configured to determine one or more display parameters for displaying intake instructions in a GUI associated with information intake viewer 127 running on client computing device 104. For example, intake instruction component 106 may adjust the display of intake instructions based on the type of the display associated with client computing device 104 (e.g., OHMD).

In some embodiments, intake instruction component 106 may obtain device information from client computing device 104 related to its type, size of display, functional specifications, and other such information. Further, intake instruction component 106 may use the device information to obtain one or more display rules associated with that device. In some embodiments, intake instruction component 106 may determine a set of display instructions for displaying intake instructions in a format for optimized display on client computing device 104 based on the one or more display rules associated with client computing device 104.

In some embodiments, intake analytics component 116 may be configured to provide programmed instructions for executing one or more reporting operations associated with the intake process.

In some embodiments, intake analytics component 116 may be configured to generate a report based on the information captured by user 160, i.e., information obtained by vehicle information component 108, owner information component 110 claim assignment component 112, and/or damage information component 114. In some embodiments, intake analytics component 116 may transmit the report to another party or system. In some embodiments, the report generated by intake analytics component 116 may comprise an insurance claim that may be transmitted to an insurance carrier or another party. In some embodiments, intake analytics component 116 may be configured to effectuate presentation of the report in a GUI associated with information intake viewer 127 running on client computing device 104 so it can be accessed and viewed by user 160.

In some embodiments, intake analytics component 116 may determine a level of completion and a level of success associated with individual intake instructions (e.g., performing vehicle, owner, and damage information intake) as they are followed by the intake technician and generate a report detailing this information, as described in detail below. Intake completion information may be obtained from client computing device 104, including one or more captured images or other data related to particular information intake.

In some embodiments, intake analytics component 116 may be configured to determine if a particular information intake process has been completed based on user generated input. For example, user 160 may transmit a voice command via microphone 119 (illustrated in FIG. 3B) of client computing device 104, or a gesture command indicating that a particular information intake process has been completed.

In other embodiments, intake analytics component 116 may be configured to determine if particular information has been captured based other information obtained from client computing device 104. For example, the intake process of particular information may include information related to the time it normally takes to capture that information (e.g., average time). For example, upon determining that the time required to capture vehicle information has elapsed, intake analytics component 116 may ask user 160 to confirm the completion of vehicle information. In yet other embodiments, intake analytics component 116 may determine that information related to the vehicle has been captured upon receiving input that user 160 has started capturing owner information, and so on.

In some embodiments, intake analytics component 116 may be configured to request intake completion information from user 160. For example, intake analytics component 116 may generate a request for additional information related to the intake and transmitting it to client computing device 104. In some embodiments, the request may include an audio prompt outputted by speaker 118 (illustrated in FIG. 3B) of client computing device 104.

In some embodiments, intake analytics component 116 may be configured to provide real time or near real time feedback based on the analysis of intake completion information. For example, upon determining that a particular information was not captured and/or not captured successfully, intake analytics component 116 may generate a message or a voice output indicating that user 160 must repeat the intake process or capture additional information.

In some embodiments, intake analytics component 116 may use the intake completion information to determine whether particular information was captured successfully. For example, the quality of images related to the vehicle damage captured by user 160 may be analyzed to determine if the images conform to one or more image quality standards, for example image standards mandated by an insurance carrier. In some embodiments, intake analytics component 116 may obtain one or more stored image quality attributes parameters (e.g., sharpness, noise, contrast, color accuracy, and so on) to analyze and confirm that the image meets these parameters, i.e., was captured correctly.

As alluded to above, a conventional intake information process is largely dependent on the intake technician entering data from multiple sources using a variety of input techniques (e.g., manually typing in VIN and owner information, uploading images from a digital camera). Because no verification process ensures quality of the data, traditional input methods are error-prone and time consuming, and may require the input technician to provide supplemental data, thus further prolonging the claim adjustment time. By automatically verifying the accuracy of captured information, improves the wait time associated with receiving a claim adjustment.

In some embodiments, intake analytics component 116 may obtain information related to the time taken to complete the entire intake process and/or to capture particular information. The actual time may then be compared to the estimated or target time for capturing particular information or completing the intake process. Next, the actual time may be analyzed with respect to the estimated time. The results of the analysis (e.g., performance analysis metric) may be used during future intake processes and/or during training. That is, analyzing the actual time with respect to the estimated time allows tracking individual employee performance, resulting in improved overall intake performance. Additionally, this data can be used for future training opportunities. In other embodiments, intake analytics component 116 may obtain information related to the information obtained during the intake by individual employees. For example, number of images taken, number of images of low quality that had to be retaken, instructional steps skipped, and so on. Similar to the time of completion data, the information related to the quality of the images may be used for performance tracking purposes, as described above.

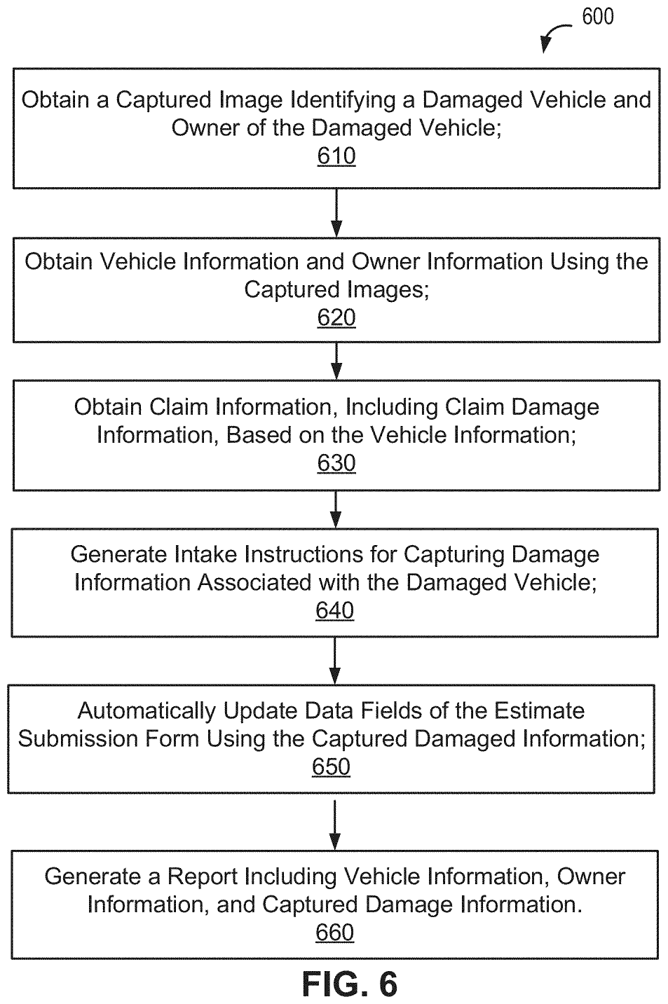

FIG. 6 illustrates a flow diagram depicting a method for automating the intake of information used to prepare a repair estimate for a damaged vehicle, in accordance with one embodiment. In some embodiments, method 600 can be implemented, for example, on a server system, e.g., information intake server 120, as illustrated in FIGS. 1-2. At operation 610, a user of a computer wearable device is directed to capture an image used to identify a damaged vehicle (e.g., VIN), and an owner of the damaged vehicle (e.g., driver's license), for example by intake capture component 106. At operation 620, vehicle information is extracted from the captured image, for example by vehicle information component 108 and owner information is extracted from the captured image, for example by owner information component 110.

At operation 630, claim information, including claim damage information is obtained using the vehicle information, for example by claim assignment component 112. At operation 640, intake instructions for capturing damage information are generated based on the claim damage information.

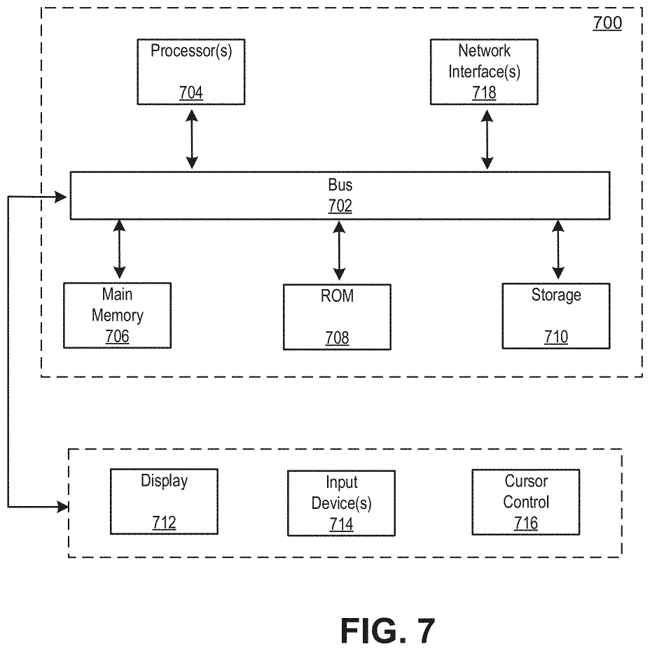

At operation 650, the intake information captured at operation 640 is used to automatically update respective data fields of an estimate submission form. At operation 650, upon capturing the intake information, a report including vehicle information, owner information, and damage information is generated, for example by intake analytics component 116.

Where circuits are implemented in whole or in part using software, in one embodiment, these software elements can be implemented to operate with a computing or processing system capable of carrying out the functionality described with respect thereto. One such example computing system is shown in FIG. 7. Various embodiments are described in terms of this example-computing system 700. After reading this description, it will become apparent to a person skilled in the relevant art how to implement the technology using other computing systems or architectures.

FIG. 7 depicts a block diagram of an example computer system 700 in which various of the embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a transparent heads-up display (HUD) or an optical head-mounted display (OHMD), for displaying information to a computer user. An input device 714, including a microphone, is coupled to bus 702 for communicating information and command selections to processor 704. An output device 716, including a speaker, is coupled to bus 702 for communicating instructions and messages to processor 704.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 705. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 705. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
obtaining vehicle identification information and owner information by processing images captured by a computing device operated by a user, wherein the vehicle identification information and the owner information are associated with a damaged vehicle damaged during an adverse incident;
obtaining insurance claim information based on the vehicle identification information and the owner information, the insurance claim information comprising damage information specifying one or more damaged parts of the damaged vehicle, and insurance intake parameters specifying one or more intake parameters; and
determining damage intake instruction information based on the damage information and insurance intake parameters associated with the insurance claim information, wherein the damage intake instruction information comprises user instructions for capturing the information associated with the one or more damaged parts of the damaged vehicle.

2. The method of claim 1, further comprising:
extracting Vehicle Identification Number (VIN) from a captured image of the vehicle identification information; and
obtaining vehicle information associated with the damaged vehicle based on the extracted VIN, wherein the vehicle information comprises a year of manufacture, a make, a model, a sub-model, a configuration, an engine type, and a transmission type of the damaged vehicle.

3. The method of claim 2, wherein obtaining vehicle identification information comprises receiving user input confirming the vehicle information.

4. The method of claim 1, wherein the owner information comprises a captured image of an owner driver's license card and an owner's insurance card.

5. The method of claim 4, further comprising extracting owner's name from the captured image of the owner driver's license card, and extracting owner's insurance policy number from the captured image of the owner information.

6. The method of claim 5, wherein obtaining insurance claim information is determined based on the extracted owner's name and the extracted owner's insurance policy number.

7. The method of claim 1, wherein the one or more intake parameters include a number of images depicting the one or more damaged vehicle parts.

8. The method of claim 1, wherein the determined damage intake instruction information comprises at least one of textual instructions and voice instructions directing the user to capture images of the one or more damaged vehicle parts associated with the damaged vehicle.

9. The method of claim 1, further comprising effectuating presentation of the damage intake instruction information for capturing the one or more damaged parts associated with the damaged vehicle using an image capture device of the computing device operated by the user;
wherein effectuating presentation of the damage intake instruction information comprises displaying the textual instructions on a display of the computing device and transmitting the voice instructions via a speaker of the computing device.

10. The method of claim 1, wherein the computing device comprises a wearable computing device worn by the user configured to facilitate hands-free intake of information associated with the owner and the damaged vehicle.

11. A system for automating an information intake process, the system comprising one or more physical processors configured by machine-readable instructions to:
obtain vehicle identification information and owner information by processing images captured by a computing device operated by a user, wherein the vehicle identification information and the owner information are associated with a damaged vehicle damaged during an adverse incident;
obtain insurance claim information based on the vehicle identification information and the owner information, the insurance claim information comprising damage information specifying one or more damaged parts of the damaged vehicle, and insurance intake parameters specifying one or more intake parameters; and
determine damage intake instruction information based on the damage information and insurance intake parameters associated with the insurance claim information, wherein the damage intake instruction information comprises user instructions for capturing the information associated with the one or more damaged parts of the damaged vehicle.

12. The system of claim 11, wherein the one or more physical processors are further configured to:
extract Vehicle Identification Number (VIN) from a captured image of the vehicle identification information; and
obtain vehicle information associated with the damaged vehicle based on the extracted VIN, wherein the vehicle information comprises a year of manufacture, a make, a model, a sub-model, a configuration, an engine type, and a transmission type of the damaged vehicle.

13. The system of claim 2, wherein the vehicle identification information is confirmed by user input.

14. The system of claim 11, wherein the owner information comprises a captured image of an owner driver's license card and an owner's insurance card.

15. The system of claim 4, the one or more physical processors are further configured to extract an owner's name from the captured image of the owner driver's license card, and extract the owner's insurance policy number from the captured image of the owner information.

16. The system of claim 5, wherein obtaining insurance claim information is determined based on the extracted owner's name and the extracted owner's insurance policy number.

17. The system of claim 11, wherein the one or more intake parameters include a number of images depicting the one or more damaged vehicle parts.

18. The system of claim 11, wherein the determined damage intake instruction information comprises at least one of textual instructions and voice instructions directing the user to capture images of the one or more damaged vehicle parts associated with the damaged vehicle.

19. The system of claim 11, the one or more physical processors are further configured to effectuate presentation of the damage intake instruction information for capturing the one or more damaged parts associated with the damaged vehicle using an image capture device of the computing device operated by the user;
wherein effectuating presentation of the damage intake instruction information comprises displaying the textual instructions on a display of the computing device and transmitting the voice instructions via a speaker of the computing device.

20. The system of claim 11, wherein the computing device comprises a wearable computing device worn by the user configured to facilitate hands-free intake of information associated with the owner and the damaged vehicle.

21. A non-transitory machine readable medium having stored thereon instructions comprising executable code which when executed by one or more processors, causes the processors to:
obtain vehicle identification information and owner information by processing images captured by a computing device operated by a user, wherein the vehicle identification information and the owner information are associated with a damaged vehicle damaged during an adverse incident;
obtain insurance claim information based on the vehicle identification information and the owner information, the insurance claim information comprising damage information specifying one or more damaged parts of the damaged vehicle, and insurance intake parameters specifying one or more intake parameters;
determine damage intake instruction information based on the damage information and insurance intake parameters associated with the insurance claim information, wherein the damage intake instruction information comprises user instructions for capturing the information associated with the one or more damaged parts of the damaged vehicle; and
effectuate presentation of the damage intake instruction information for capturing the one or more damaged parts associated with the damaged vehicle using an image capture device of the computing device operated by the user;
wherein effectuating presentation of the damage intake instruction information comprises displaying the textual instructions on a display of the computing device and transmitting the voice instructions via a speaker of the computing device.
